(19) United States
(12) Patent Application Publication
(10) Pub. No.: US 2011/0085879 A1
(43) Pub. Date: Apr. 14, 2011

(54) PORTABLE BIN

(75) Inventors: Thomas Alexander Garfield Jamieson, South Yarra (AU); Dale Patrick Cooney, Glen Iris (AU)

(73) Assignee: TRAILER TRASH PTY LTD, South Melbourne (AU)

(21) Appl. No.: 12/896,978

(22) Filed: Oct. 4, 2010

(30) Foreign Application Priority Data
Oct. 2, 2009 (AU) 2009904793

(51) Int. Cl. B65G 65/34; B62D 63/06; B62D 63/08; B60P 1/04; B65D 88/02

(52) U.S. Cl. 414/425; 280/400; 414/482; 414/810; 220/694

(57) ABSTRACT

A bin, including a receptacle movable between a first condition of use for loading and a second condition of use in which it can be engaged for emptying; and attachment means including first and second elongate sleeves for engagement by respective forks of a front lift truck, wherein in the second condition of use the receptacle is arranged in a manner whereby forks of a front lift truck can engage respective sleeves of the attachment means so that the bin can be lifted and emptied by the truck.

### TECHNICAL FIELD OF THE INVENTION

The present invention relates to a bin, a portable bin, an apparatus for moving a bin between a first condition of use for loading and a second condition of use for emptying and a method of emptying a bin.

### BACKGROUND OF THE INVENTION

Trailer mounted bins are generally convenient because they are transportable between work sites and can be emptied on site by front lift trucks, thereby eliminating the need to transport them to transfer stations for emptying, for example. A typical front lift truck used to empty one of these bins includes hydraulically operable arms which move between a bin engaging position, where forks of the arms are coupled to corresponding sleeves of the bins, and an emptying position, where the bin is raised and rotated to a position where its contents falls under gravity from the bin into a receptacle of the truck. The sleeves are arranged horizontally on the sides of the bin for engagement with corresponding forks as the truck is driven up to the front of the bin.

Typical front lift trucks have a limited capacity to empty bins which are over a certain length because the longer the bin, the further the centre of mass is from the point of leverage applied to the forks. In some circumstances, it is may be desirable to use a bin with a large capacity on a building site, for example.

It is generally possible to increase the load capacity of the bins by making them deeper. However, bins over a certain depth may be generally inconvenient to load manually.

It is generally desirable to overcome or ameliorate one or more of the above mentioned difficulties, or at least provide a useful alternative.

### SUMMARY OF THE INVENTION

In accordance with one aspect of the invention, there is provided a bin for storing waste products, including:
(a) a receptacle shaped to receive and store waste products; and
(b) attachment means coupled to the receptacle including first and second elongate sleeves arranged for engagement with respective forks of a front lift waste truck,
   wherein the bin is movable between a first condition of use for receiving and storing waste products and a second condition of use whereby forks of a front lift waste truck can engage respective sleeves of the attachment means so as to lift and empty the bin.

Preferably, a distance between a centre of mass of the bin and a bottom side of the bin that overlies a floor or ground surface is greater when arranged in the second condition of use than the first condition of use.

Preferably, a centre of mass of the bin is closer to a leverage point of the forks when arranged in the second condition of use than the first condition of use.

Preferably, the receptacle is generally cuboid having a base, a top, sides and ends, and in the first condition of use the base of the receptacle is lowermost and in the second condition of use an end of the receptacle is lowermost.

In accordance with one aspect of the invention, there is provided a portable bin, including a trailer and the above-described bin, wherein the portable bin is separable from the trailer for emptying.

Preferably, the trailer includes a tipping device to tilt and empty the bin for unloading.

In accordance with one aspect of the invention, there is provided an apparatus for moving the bin claimed in any one of claims 1 to 13 between a first condition of use for loading and second condition of use for emptying, including:
(a) a frame; and
(b) first and second cables, each coupled to the frame and arranged to extend and retract independently of each other,
   wherein the cables are arranged to selectively engage the bin at predetermined locations to move it from the first condition of use to the second condition of use.

Preferably, the first and second cables are arranged to engage opposite first and second end sections of the bin and to retract so as to lift the bin vertically.

Preferably, the first and second cables are arranged to retract and extend to as to raise and lower respective end sections of the bin.

Preferably, the second cable is arranged to engage the first end section and retract with the first cable to further raise the first end section of the bin vertically.

In accordance with one aspect of the invention, there is provided a method of emptying the above described bin, the method including the steps of:
(a) moving the bin from a first condition of use to a second condition of use;
(b) engaging the attachment means; and
(c) emptying the bin by lifting and tilting the bin so that objects contained therein fall from the receptacle.

Preferably, the step of moving the receptacle from the first condition of use to the second condition of use is performed by tipping the bin onto an end.

Preferably, the step of moving the receptacle from the first condition of use to the second condition of use includes the step of lifting the bin from a trailer prior to tipping the receptacle.

Preferably, the step of moving the receptacle from the first condition of use to the second condition of use includes the step of tilting and lowering the receptacle so that an edge of an end of the receptacle is supported on a surface below the receptacle, and lifting the receptacle so that an opposite end of the receptacle is raised.

Preferably, the step of emptying the bin is performed by a conventional front lift truck.

In accordance with one aspect of the invention, there is provided a bin for storing waste products, including:
(a) a receptacle shaped to receive and store waste products;
(b) first attachment means coupled to the receptacle and arranged for engagement with the forks of a forklift; and
(c) second attachment means coupled to the receptacle including first and second elongate sleeves arranged for engagement with respective forks of a front lift waste truck,
   wherein the bin is movable by a forklift in engagement with the first attachment means between a first condition of use for receiving and storing waste products and a second condition of use whereby forks of a front lift waste truck can engage respective sleeves of the second attachment means so as to lift and empty the bin.

Preferably, a distance between a centre of mass of the bin and a bottom side of the bin that overlies a floor or ground surface is greater when arranged in the second condition of use than the first condition of use.

Preferably, a centre of mass of the bin is closer to a leverage point of the forks when arranged in the second condition of use than the first condition of use.

Preferably, the receptacle is generally cuboid having a base, a top, sides and ends, and in the first condition of use the base of the receptacle is lowermost and in the second condition of use an end of the receptacle is lowermost.

Preferably, the first attachment means includes elongate sleeves coupled to the base of the receptacle.

Preferably, the elongate sleeves are arranged for engagement by the forks of a forklift, the forklift having a rotating fork attachment for rotating the forks.

In accordance with one aspect of the invention, there is provided a portable bin, including a trailer and the above describe bin, wherein the portable bin is separable from the trailer for emptying.

Preferably, the trailer includes a tipping device to tilt and empty the bin for unloading.

In accordance with one aspect of the invention, there is provided a method of emptying the above described bin, the method including the steps of:
(a) engaging the first attachment means with a forklift to move the bin from a first condition of use to a second condition of use;
(b) engaging the second attachment means; and
(c) emptying the bin by lifting and tilting the bin so that objects contained therein fall from the receptacle.

Preferably, the step of moving the bin from the first condition of use to the second condition of use is performed by lifting the bin with a forklift having a rotating fork attachment, rotating the bin and resting it on an end.

Preferably, the step of moving the bin from the first condition of use to the second condition of use includes the step of lifting the bin from a trailer prior to rotating the bin.

Preferably, the bin is lifted from the trailer by a forklift.

Preferably, the step of emptying the bin is performed by a conventional front lift truck.

### BRIEF DESCRIPTION OF THE DRAWINGS

Preferred embodiments of the present invention are hereafter described, by way of non-limiting example only, with reference to the accompanying drawing in which:

FIG. 1 is a side view of a portable bin;

FIG. 2 is another side view of the portable bin shown in FIG. 1 arranged in another condition of use;

FIG. 3 is a side view of the bin shown in FIG. 1 arranged in a condition of use;

FIG. 4 is a side view of the bin shown in FIG. 3 arranged in another condition of use;

FIG. 5 is a side view of the bin shown in FIG. 4 coupled to forks of a front lift waste truck;

FIG. 6 is a side view of the portable bin shown in FIG. 1 with a tipping device;

FIG. 7 is a side view of the portable bin shown in FIG. 6 arranged in another condition of use;

FIG. 8 is a side view of the bin shown in FIG. 1 coupled to apparatus for moving the bin between conditions of use;

FIGS. 9 and 10 are side views of the apparatus of FIG. 8, the apparatus moving the bin between conditions of use;

FIG. 11 is a side schematic view of the apparatus of FIG. 8 and a bin in a second condition of use;

FIG. 12 is a side view of another portable bin;

FIG. 13 is another side view of the portable bin shown in FIG. 12 arranged in another condition of use;

FIG. 14 is a side view of the bin shown in FIG. 13 coupled to forks of a forklift; and

FIG. 15 is a side view of the bin shown in FIG. 14 arranged in another condition of use.

### DETAILED DESCRIPTION OF PREFERRED EMBODIMENTS OF THE INVENTION

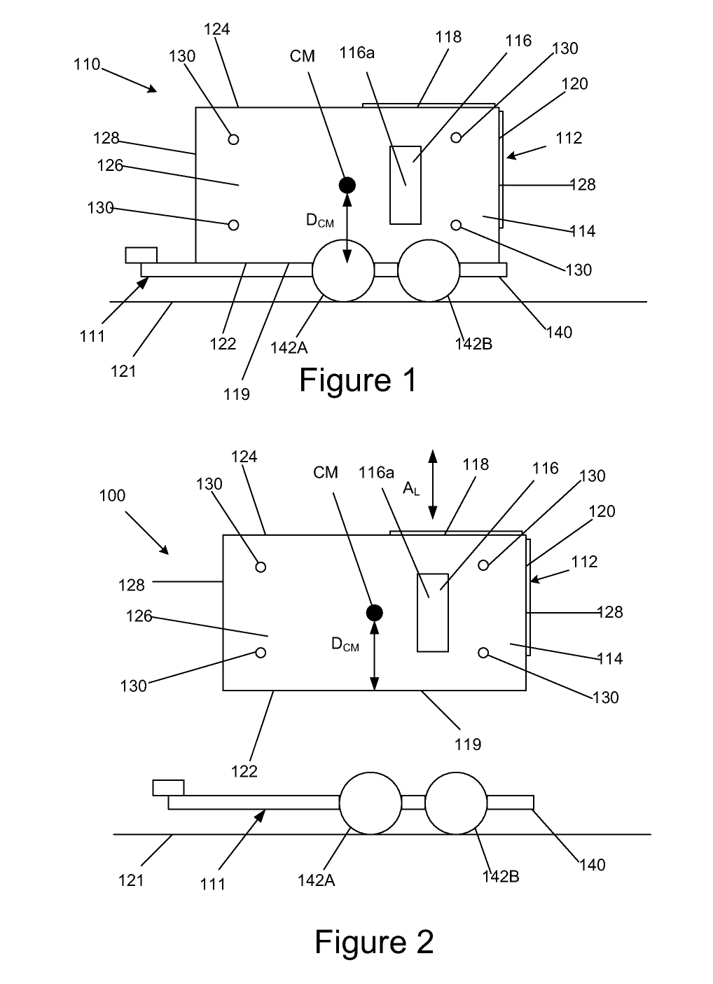

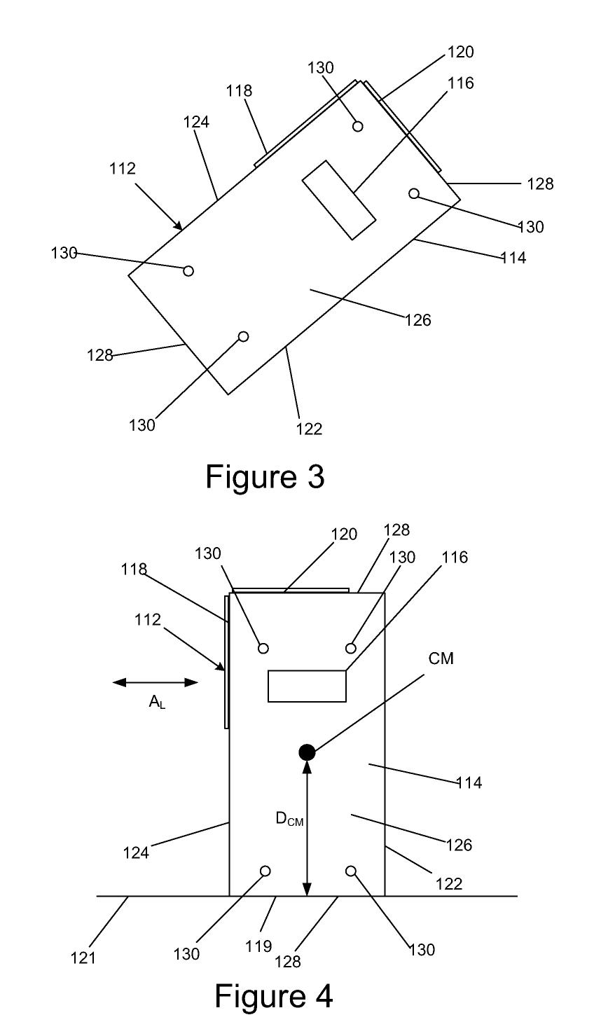

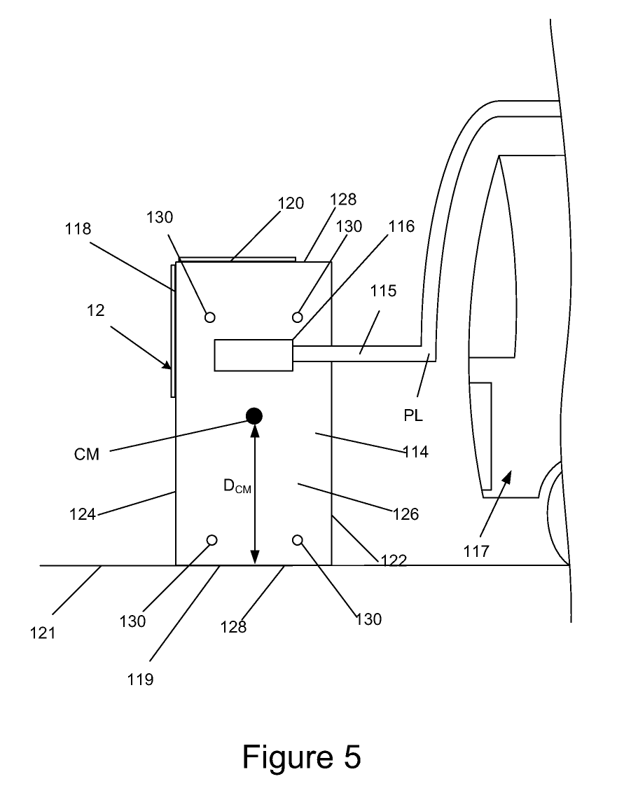

The portable bin 100 shown in FIG. 1 includes a trailer 111 and a bin 112, wherein the bin 112 is separable from the trailer 111 for emptying. The bin 112 includes a receptacle 114 shaped to receive and store waste products; and attachment means 116 coupled to the receptacle 114 including first and second elongate sleeves 116a, 116b arranged for engagement with respective forks 15 of a front lift waste truck 117. The bin 112 is movable between the first condition of use shown in FIG. 1 for receiving and storing waste products, and the second condition of use shown in FIGS. 4 and 5 whereby forks 115 of the front lift waste truck 117 can engage respective sleeves 116a, 116b of the attachment means 116 so as to lift and empty the bin 112. A distance D_{CM} between a centre of mass “CM” of the bin 112 and a bottom side 119 of the bin 112 that overlies a floor or ground surface 121 is greater when arranged in the second condition of use than the first condition of use. In other words, as particularly shown in FIG. 5, the centre of mass “CM” of the bin 112 is closer to a leverage point “LP” of the forks 115 when arranged in the second condition of use than the first condition of use.

The receptacle 114 is generally cuboid having a base 122, a top 124, sides 126 and ends 128. In the first condition of use, the base 122 of the receptacle 114 is lowermost and in the second condition of use an end 128 of the receptacle 114 is lowermost. The receptacle 114 may be made of any suitable commercially available material, such as mild steel for example.

The length of the sides 26 of the receptacle 114 are such that when in the first condition of use, the bending load imparted by the bin 112 on forks 115 of a front lift truck 117 attempting to lift the bin 112, is greater than the bending load applied to the forks 115 of a front lift truck 117 attempting to lift the bin 112 when arranged in the second condition of use. In the embodiment shown, the length of the sides 126 are about 6 metres in length.

The receptacle 114 has a first aperture 118 through which the bin can be loaded and a second aperture 120 through which the bin can be emptied. In the embodiment shown, the first aperture 118 and the second aperture 120 are separately formed. In other forms, the first aperture 118 and the second aperture 120 may be combined.

The first aperture 118 is disposed on the top 124 of the receptacle 114 and the second aperture 120 disposed on the end 128 which is uppermost in the second condition of use. The first aperture 118 and the second aperture 120 are closable, and in the embodiment shown are lockable to prevent unwanted access. In one form, the apertures 118, 120 are covered by conventional plastic covers.

The bin 112 includes at least two fixing points 130 coupled to the receptacle 114 and adapted to be engaged when the receptacle 114 is in the first condition of use so that the receptacle can be moved to the second condition of use.

The bin 112 is emptied by lifting and tilting the receptacle 114 so that objects contained therein pass through the second aperture 120. The bin 112 is arranged to be emptied by a conventional front lift waste truck 117. In use, the front lift truck 117 would engage the attachment means 116 to lift and tilt the receptacle 114 until it is almost inverted. Waste items contained in the receptacle 114 falls out due to the action of gravity and are received in a receptacle of the front lift truck 117 for transportation to a land fill site, for example. The capacity of the receptacle of the front lift truck 117 is many times greater than that of the bin 112, therefore a number of portable bins 100 may be emptied by the front lift truck 117, thereby eliminating the need for the bins 112 to be transported to a landfill site for emptying.

In the embodiment shown, the receptacle 114 has an attachment means 116 coupled to each side of it. In one form, each attachment means 116 is an elongate pocket configured to receive a fork of a front lift truck so that the bin can be emptied. In the first condition of use, a longitudinal axis “A_{L}” of the pocket is generally vertical, and in the second condition of use is generally horizontal.

The trailer 111 includes a chassis 140 and wheels 142a, 142b. Advantageously, a portable bin 100 can be easily transported between work sites as needed.

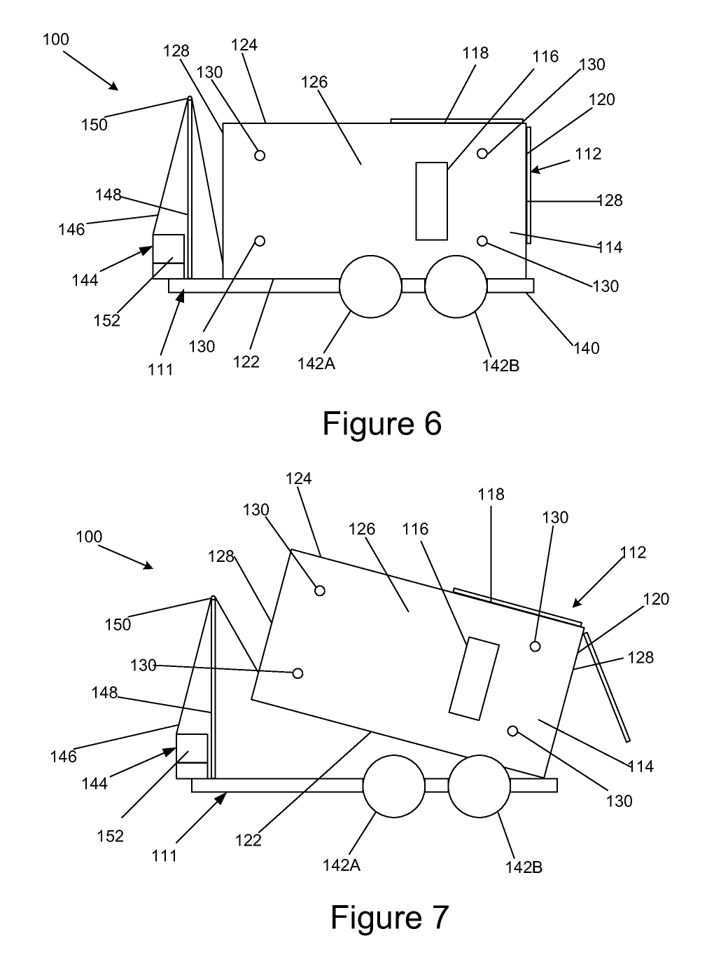

With reference to FIGS. 6 and 7, in one form the portable bin 100 includes a tipping device 144 to tilt and empty the bin 112 off the trailer 111. The portable bin 100 may be taken to a landfill site so that the bin 112 can be emptied if the bin 112 is loaded to a level with inhibits a front lift truck 127 from lifting the bin 112, for example. In one form, the tipping device 144 includes a cable 146, one end of which is coupled to a lower portion of the receptacle 124, and the other end coupled to the portable bin 100 so that drawing the cable 146 will lift one end of the bin 112 to tilt it.

The cable 146 passes over a roller 150 disposed at a position elevated above the lower portion of the bin at which the cable 146 is coupled to the receptacle 114. The roller is supported by a post 148. Post 148 may be made of any suitable commercially available material, such as mild steel for example. In the embodiment shown, the cable 146 is drawn by a winch 152. The winch may, for example, be an electric winch.

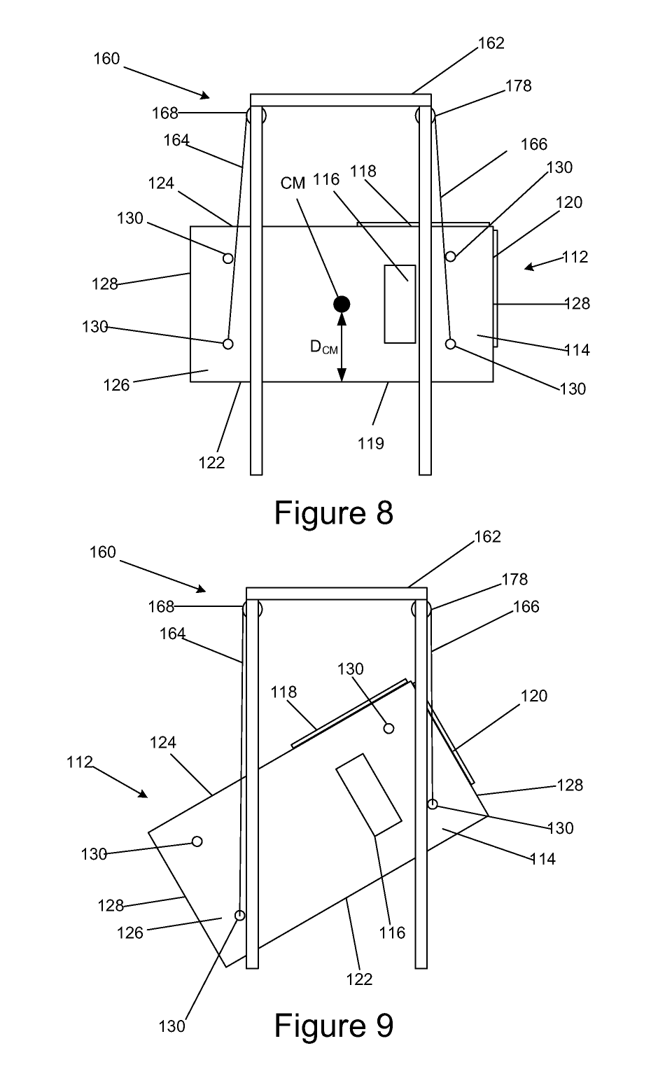

With reference to FIGS. 8 to 11, there is provided an apparatus 160 for moving a receptacle 114 of a bin 112 between a first condition of use for loading and second condition of use for emptying. The apparatus 160 includes a frame 162, a first cable 164 and a second cable 166. Each cable 164, 166 is coupled to the frame 162 and arranged to extend and retract independent of each other. The cables 164, 166 are arranged to selectively engage the receptacle 114 at predetermined locations to move it from the first condition of use to the second condition of use. In one form, the predetermined locations are fixing points 130 coupled to the receptacle. Fixing points 130 may, for example, be formed in the receptacle 114 or attached thereto, by welding for example.

Apparatus 160 may be transportable so that a front lift truck may travel between portable bins located at different worksites to enable them to be emptied by a front lift truck. Alternatively, apparatus 160 may be provided at an intermediate location to enable portable bins to be taken and emptied by a front lift truck without having to travel to a landfill site.

As can be seen in FIGS. 8 to 11, the apparatus 160 is arranged to move the receptacle 114 from the first condition of use to the second condition of use by tipping it onto an end 128 of the receptacle 114.

In the first condition of use, the bin 112 may be attached to a portable bin 110, and will require the apparatus to lift the bin 112 from the portable bin 100 prior to moving the receptacle 114 from the first condition of use to the second condition of use. To achieve this, both cables 164, 166 engage the receptacle 114 and retract at the same time.

As can be seen in FIG. 9, in moving the receptacle 114 from the first condition of use to the second condition of use, the first cable 164 is arranged to advance after lifting the bin 112 to lower an edge of an end 128 of the receptacle 114 so that the edge rests on the ground, or a surface arranged to take the weight of the bin 112. The second cable 166 is arranged to retract after the end of the receptacle 114 has been lowered to lift an opposite end to tip the receptacle 114. In one form, the first cable 164 is arranged to disengage from the receptacle 114 after the end 128 has been lowered and the weight supported by the second cable 166. The first cable 164 is movable between fixing points 130 after the end 128 has been lowered.

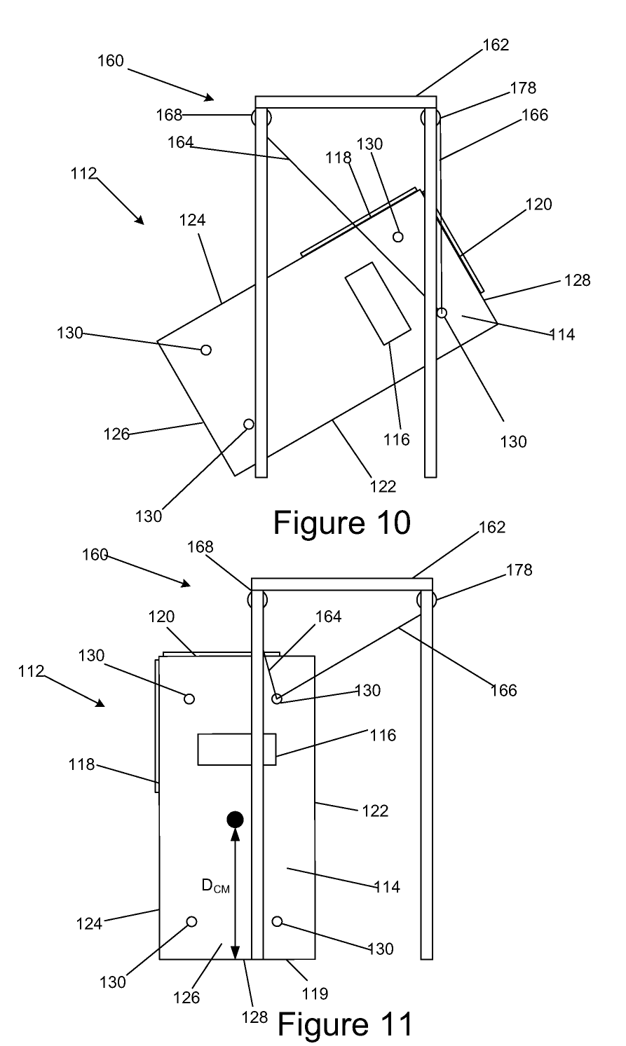

As can be seen in FIG. 10, the first cable 164 is arranged to engage the receptacle 114 at the same predetermined location which the second cable 166 is engaged after the end 128 has been lowered and the first cable 64 disengaged.

In the embodiment shown, the frame 162 is a space frame which is a truss-like, lightweight rigid structure constructed from interlocking struts in a geometric pattern. The frame 162 has members which may be made from any suitable commercially available material, such as mild steel or aluminium, for example. The frame 162 may be fastened using any suitable fastening method, such as nuts and bolts or welding for example.

The first and second cables 164, 166 are coupled to first and second retraction means 168, 170 respectively to advance and retract the cables 164, 166. Each retraction means 168, 170 may be movable relative to the frame 162 to assist in moving the receptacle 114 from the first condition of use to the second condition of use. Each retraction means 168, 170 may be slidably coupled to the frame to allow them to move relative to the frame 162.

In one form, at least one of the first and second retraction means 168, 170 is an electric winch. The or each electric winch may be manually operated, or may be controlled by a controller (not shown). The controller may be programmable.

The method of emptying the above describe bin 112 includes the steps of moving the receptacle 114 from a first condition of use to a second condition of use, engaging the at least one attachment means 116, and emptying the bin 112 by lifting and tilting the receptacle 114 so that objects contained therein fall from the receptacle 114.

The step of moving the receptacle 114 from the first condition of use to the second condition of use is performed by tipping the receptacle 114 onto an end 128. The step of moving the receptacle 114 from the first condition of use to the second condition of use may include the step of lifting the bin 112 from a portable bin prior 100 to tipping the receptacle 114.

The step of moving the receptacle 114 from the first condition of use to the second condition of use includes the step of tilting and lowering the receptacle 114 so that an edge of an end 128 of the receptacle 114 until it is supported on a surface below the receptacle 114, and lifting the receptacle 114 so that an opposite end 128 of the receptacle 114 is raised.

In this method, the step of emptying the bin is performed by a conventional front lift truck.

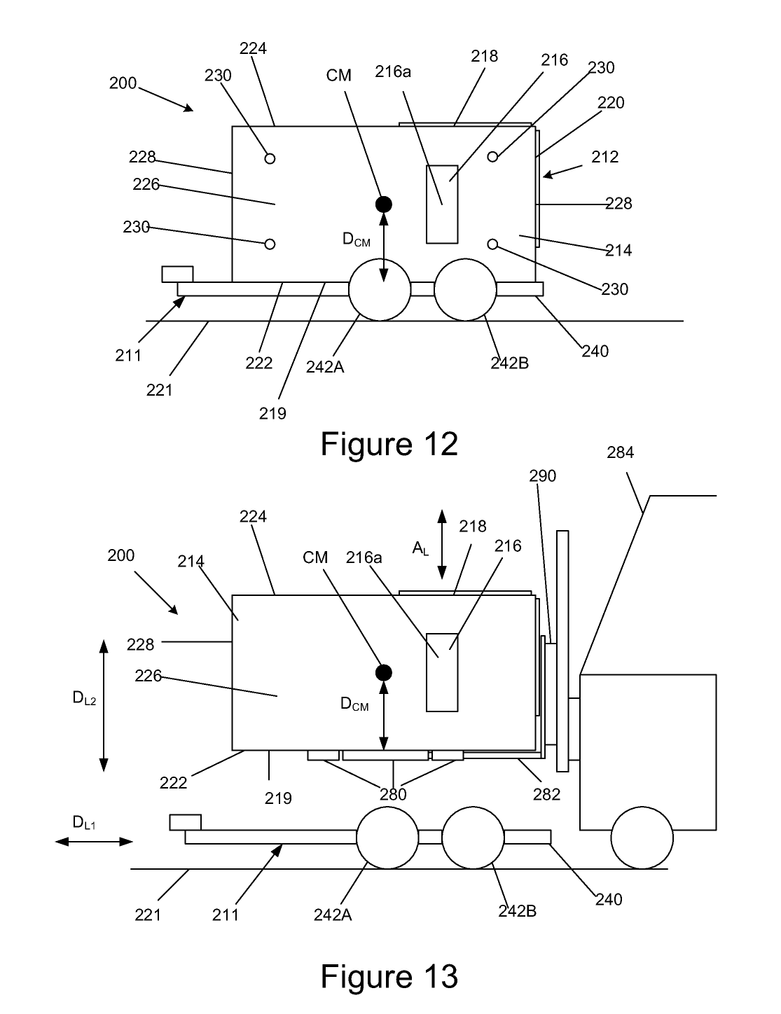

The portable 200 shown in FIGS. 12 to 15 includes a trailer 211 and a bin 212, wherein the bin 212 is separable from the trailer 211 for emptying. The bin 212 includes a receptacle 214 shaped to receive and store waste products; first attachment means 280 coupled to the receptacle 214 and arranged for engagement with the forks 282 of a forklift 282; and second attachment means 216 coupled to the receptacle 214 including first and second elongate sleeves 216a, 216b arranged for engagement with respective forks 215 of a front lift waste truck 217. The bin 212 is movable by a forklift 284 in engagement with the first attachment means 280 between a first condition of use shown in FIG. 12 for receiving and storing waste products and a second condition of use shown in FIG. 15 whereby forks 215 of a front lift waste truck 217 can engage respective sleeves 216a, 216b of the second attachment means 216 so as to lift and empty the bin 200.

The first attachment means 280 includes elongate sleeves 286a, 286b, 288a, 288b coupled to the base of the receptacle. The first attachment means 280 includes two sets of substantially parallel elongate sleeves 286,288. A longitudinal axis of each set of sleeves is arranged at an angle to each other. As can be seen in FIG. 15, the longitudinal axis of the first set of elongate sleeves 286 is substantially perpendicular to a longitudinal axis of the second set of elongate sleeves 288.

The elongate sleeves 286a, 286b, 288a, 288b are arranged for engagement by the forks 282 of a forklift 284, the forklift 284 having a rotating fork attachment 290 for rotating the forks. The rotating fork attachment 290 is a standard commercially available attachment.

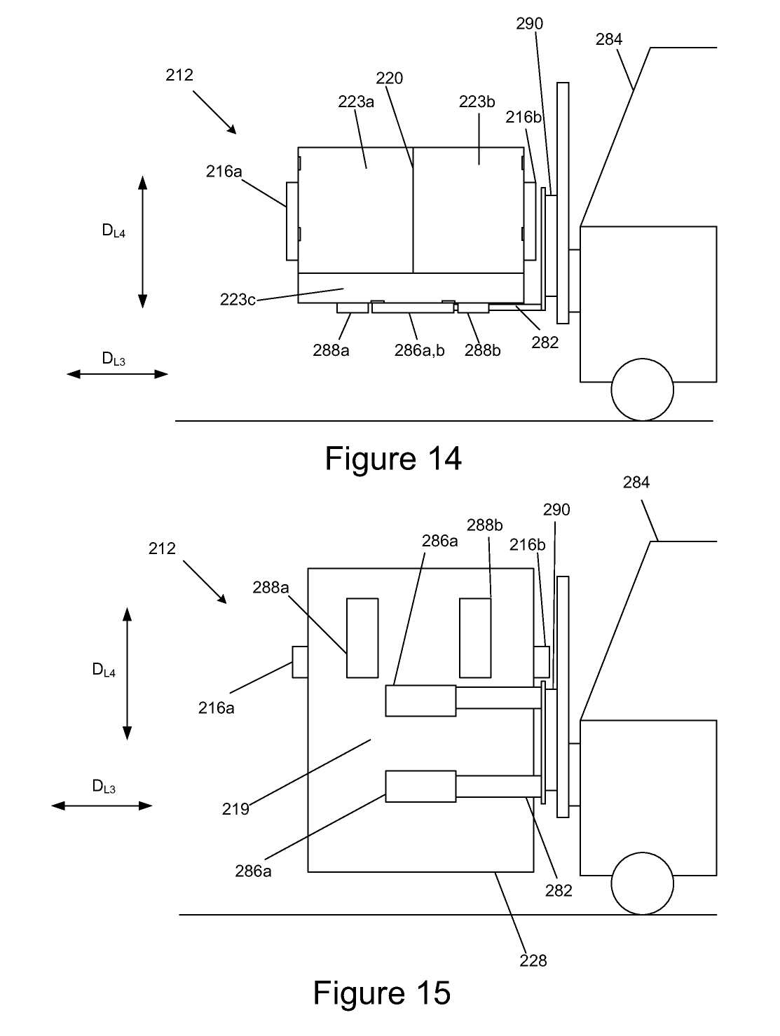

In the embodiment shown in FIG. 14, bin 212 includes hinged doors 223a, 223b, 223c arranged to swing open so that bin 212 can be opened through the second aperture 220.

The method of emptying the above described bin 212 includes the steps of engaging the first attachment means 280 with a forklift 284 to move the bin 200 from a first condition of use shown in FIG. 12 to a second condition of use shown in FIG. 15; engaging the second attachment means 216; and emptying the bin 212 by lifting and tilting the bin 200 so that objects contained therein fall from the receptacle 214.

In the embodiment shown in FIG. 13, the bin 212 is lifted from the trailer 211 by a forklift 284. Chassis 240 of trailer 211 has recesses (not shown) to allow the forks 282 of forklift 284 to pass below the bin 212 and engage the first attachment means 280. To engage the first attachment means 280, the forklift 284 advances toward the bin 212 in direction D_{L1} so that forks 282 of forklift 284 engage elongate sleeves 288a, 288b. The bin 212 is then lifted from the trailer 211 in direction D_{L2}.

The bin 212 is then placed on the ground or other support and the forks 282 of the forklift 284 disengaged from the first attachment means 280.

The step of moving the bin 212 from the first condition of use to the second condition of use is performed by lifting the bin 212 with a forklift 284 having a rotating fork attachment 290, rotating the bin 212 and resting it on an end 228. To move the bin 212 from the first condition of use to the second condition of use, elongate sleeves 286a, 286b of the bin 212 are engaged by advancing the forks 282 of the forklift 284 along directions D_{L3}. The bin 212 is then lifted along direction D_{L4} and rotated so that it may rest on end 228.

The step of moving the bin 212 from the first condition of use to the second condition of use may include the step of lifting the bin 212 from a trailer 211 prior to rotating the bin 212.

Once in the second condition of use, the bin 212 is then in a position to be emptied, and in this method, the step of emptying the bin is performed by a conventional front lift truck.

While we have shown and described specific embodiments of the present invention, further modifications and improvements will occur to those skilled in the art. We desire it to be understood, therefore, that this invention is not limited to the particular forms shown and we intend in the append claims to cover all modifications that do not depart from the spirit and scope of this invention.

Throughout this specification, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference to any prior art in this specification is not, and should not be taken as, an acknowledgment or any form of suggestion that the prior art forms part of the common general knowledge in Australia.

1. A bin for storing waste products, including:
(a) a receptacle shaped to receive and store waste products; and
(b) attachment means coupled to the receptacle including first and second elongate sleeves arranged for engagement with respective forks of a front lift waste truck,
wherein the bin is movable between a first condition of use for receiving and storing waste products and a second condition of use whereby forks of a front lift waste truck can engage respective sleeves of the attachment means so as to lift and empty the bin.

2. The bin claimed in claim 1, wherein a distance between a centre of mass of the bin and a bottom side of the bin that overlies a floor or ground surface is greater when arranged in the second condition of use than the first condition of use.

3. The bin claimed in claim 1 or claim 2, wherein a centre of mass of the bin is closer to a leverage point of the forks when arranged in the second condition of use than the first condition of use.

4. The bin claimed in any one of claims 1 to 3, wherein the receptacle is generally cuboid having a base, a top, sides and ends, and in the first condition of use the base of the receptacle is lowermost and in the second condition of use an end of the receptacle is lowermost.

5. The bin claimed in claim 4, wherein the sides of the receptacle are about 6 metres in length.

6. The bin claimed in any one of claims 1 to 5, wherein the receptacle has a first aperture through which the bin can be loaded and a second aperture through which the bin can be emptied.

7. The bin claimed in claim 6, wherein the first and second aperture are separately formed.

8. The bin claimed in claim 6 or claim 7, wherein the first aperture is disposed on the top of the receptacle and the second aperture disposed on the end which is uppermost in the second condition of use.

9. The bin claimed in any one of claims 6 to 8, wherein the bin is emptied by lifting and tilting the receptacle so that objects contained therein pass through the second aperture.

10. The bin claimed in any one of claims 6 to 9, wherein the first aperture and the second apertures are closable.

11. The bin claimed in claim 10, wherein the first and the second apertures are lockable.

12. The bin claimed in any one of claims 1 to 9, further including at least two fixing points adapted to be engaged to move the receptacle between the first condition of use and the second condition of use.

13. The bin claimed in any one of claims 1 to 12, wherein longitudinal axes of the sleeves are generally horizontal in the second condition of use.

14. A portable bin, including a trailer and a bin as claimed in any one of claims 1 to 13, wherein the portable bin is separable from the trailer for emptying.

15. The portable bin claimed in claim 14, wherein the trailer includes a tipping device to tilt and empty the bin for unloading.

16. The portable bin claimed in claim 15, wherein the tipping device includes a cable, one end of which is coupled to a lower portion of the bin, and the other end coupled to the trailer so that drawing the cable will lift one end of the bin to tilt it.

17. The portable bin claimed in claim 16, wherein the cable passes over a roller disposed at a position elevated above the lower portion of the bin.

18. The portable bin claimed in claim 17, wherein the roller is supported by a post.

19. The portable bin claimed in any one of claims 16 to 18, wherein the cable is drawn by a winch.

20. An apparatus for moving the bin claimed in any one of claims 1 to 13 between a first condition of use for loading and second condition of use for emptying, including:
(a) a frame; and
(b) first and second cables, each coupled to the frame and arranged to extend and retract independently of each other,
wherein the cables are arranged to selectively engage the bin at predetermined locations to move it from the first condition of use to the second condition of use.

21. The apparatus claimed in claim 20, wherein the first and second cables are arranged to engage opposite first and second end sections of the bin and to retract so as to lift the bin vertically.

22. The apparatus claimed in claim 21, wherein the first and second cables are arranged to retract and extend to as to raise and lower respective end sections of the bin.

23. The apparatus claimed in claim 22, wherein the second cable is arranged to engage the first end section and retract with the first cable to further raise the first end section of the bin vertically.

24. The apparatus claimed in any one of claims 20 to 23, wherein the predetermined locations are fixing points coupled to the receptacle.

25. The apparatus claimed in any one of claims 20 to 24, wherein the frame is a space frame.

26. The apparatus claimed in any one of claims 20 to 25, wherein the first and second cables are coupled to first and second retraction means to advance and retract the cables.

27. The apparatus claimed in claim 26, wherein the retraction means are movable relative to the frame.

28. The apparatus claimed in claim 27 or claim 28, wherein the retraction means are electric winches.

29. A method of emptying the bin according to any one of claims 1 to 13, the method including the steps of:
(a) moving the bin from a first condition of use to a second condition of use;
(b) engaging the attachment means; and
(c) emptying the bin by lifting and tilting the bin so that objects contained therein fall from the receptacle.

30. The method claimed in claim 29, wherein the step of moving the receptacle from the first condition of use to the second condition of use is performed by tipping the bin onto an end.

31. The method claimed in claim 30, wherein the step of moving the receptacle from the first condition of use to the second condition of use includes the step of lifting the bin from a trailer prior to tipping the receptacle.

32. The method as claimed in any one of claims 29 to 31, wherein the step of moving the receptacle from the first condition of use to the second condition of use includes the step of tilting and lowering the receptacle so that an edge of an end of the receptacle is supported on a surface below the receptacle, and lifting the receptacle so that an opposite end of the receptacle is raised.

33. The method as claimed in claim 32, wherein the step of emptying the bin is performed by a conventional front lift truck.

34. A bin for storing waste products, including:
(a) a receptacle shaped to receive and store waste products;
(b) first attachment means coupled to the receptacle and arranged for engagement with the forks of a forklift; and
(c) second attachment means coupled to the receptacle including first and second elongate sleeves arranged for engagement with respective forks of a front lift waste truck,
wherein the bin is movable by a forklift in engagement with the first attachment means between a first condition of use for receiving and storing waste products and a second condition of use whereby forks of a front lift waste truck can engage respective sleeves of the second attachment means so as to lift and empty the bin.

35. The bin claimed in claim 34, wherein a distance between a centre of mass of the bin and a bottom side of the bin that overlies a floor or ground surface is greater when arranged in the second condition of use than the first condition of use.

36. The bin claimed in claim 34 or claim 35, wherein a centre of mass of the bin is closer to a leverage point of the forks when arranged in the second condition of use than the first condition of use.

37. The bin claimed in any one of claims 34 to 36, wherein the receptacle is generally cuboid having a base, a top, sides and ends, and in the first condition of use the base of the receptacle is lowermost and in the second condition of use an end of the receptacle is lowermost.

38. The bin claimed in claim 37, wherein the first attachment means includes elongate sleeves coupled to the base of the receptacle.

39. The bin claimed in claim 37, wherein the first attachment means includes two sets of substantially parallel elongate sleeves, the longitudinal axes of the sleeves in the first set being arranged at an angle to the other set.

40. The portable bin claimed in claim 39, wherein the longitudinal axes of the first set of elongate sleeves is substantially perpendicular to the longitudinal axes of the second set of elongate sleeves.

41. The bin claimed in any one of claims 38 to 40, wherein the elongate sleeves are arranged for engagement by the forks of a forklift, the forklift having a rotating fork attachment for rotating the forks.

42. The bin claimed in any one of claims 37 to 41, wherein the sides of the receptacle are about 6 metres in length.

43. The bin claimed in any one of claims 34 to 42, wherein the receptacle has a first aperture through which the bin can be loaded and a second aperture through which the bin can be emptied.

44. The bin claimed in claim 43, wherein the first and second aperture are separately formed.

45. The bin claimed in claim 43 or claim 44, wherein the first aperture is disposed on the top of the receptacle and the second aperture disposed on the end which is uppermost in the second condition of use.

46. The bin claimed in any one of claims 34 to 45, wherein the bin is emptied by lifting and tilting the receptacle so that objects contained therein pass through the second aperture.

47. The bin claimed in any one of claims 43 to 46, wherein the first aperture and the second apertures are closable.

48. The bin claimed in claim 47, wherein the first and the second apertures are lockable.

49. The bin claimed in any one of claims 34 to 48, wherein longitudinal axes of the sleeves of the second attachment means are generally horizontal in the second condition of use.

50. A portable bin, including a trailer and a bin as claimed in any one of claims 34 to 49, wherein the portable bin is separable from the trailer for emptying.

51. The portable bin claimed in claim 50, wherein the trailer includes a tipping device to tilt and empty the bin for unloading.

52. The portable bin claimed in claim 51, wherein the tipping device includes a cable, one end of which is coupled to a lower portion of the bin, and the other end coupled to the trailer so that drawing the cable will lift one end of the bin to tilt it.

53. The portable bin claimed in claim 52, wherein the cable passes over a roller disposed at a position elevated above the lower portion of the bin.

54. The portable bin claimed in claim 53, wherein the roller is supported by a post.

55. The portable bin claimed in any one of claims 52 to 54, wherein the cable is drawn by a winch.

56. A method of emptying the bin according to any one of claims 34 to 55, the method including the steps of:
(a) engaging the first attachment means with a forklift to move the bin from a first condition of use to a second condition of use;
(b) engaging the second attachment means; and
(c) emptying the bin by lifting and tilting the bin so that objects contained therein fall from the receptacle.

57. The method claimed in claim 56, wherein the step of moving the bin from the first condition of use to the second condition of use is performed by lifting the bin with a forklift having a rotating fork attachment, rotating the bin and resting it on an end.

58. The method claimed in claim 57, wherein the step of moving the bin from the first condition of use to the second condition of use includes the step of lifting the bin from a trailer prior to rotating the bin.

59. The method as claimed in claim 58, wherein the bin is lifted from the trailer by a forklift.

60. The method as claimed in any one of claims 57 to 59, wherein the step of emptying the bin is performed by a conventional front lift truck.
